(19) United States
(12) Patent Application Publication
(10) Pub. No.: US 2006/0201450 A1
(43) Pub. Date: Sep. 14, 2006

(54) Therapeutic use for a retractable leash

(76) Inventors: Elizabeth Jordan, Newtown, PA (US); Joseph Cannon, Philadelphia, PA (US)

Correspondence Address: STURM & FIX LLP, 206 SIXTH AVENUE, SUITE 1213, DES MOINES, IA, 50309-4076, US

(21) Appl. No.: 11/076,768

(22) Filed: Mar. 10, 2005

(51) Int. Cl. A01K 27/00

(52) U.S. Cl. 119/796

(57) ABSTRACT

A new use of a conventional retractable dog leash apparatus (10) for performing self-stretching and range-of-motion physical therapy exercises wherein, the apparatus (10) includes a retraction mechanism (30) contained within a housing member (20) and controlled by a push button (40) wherein, the retraction mechanism (30) is connected to one end (51) of a leash strap (50) the terminal end of which (52) is provided with a snap clip (60) and a stop element (70) that cooperate to form an appendage surrounding loop (80).

### CROSS REFERENCE TO RELATED APPLICATIONS

Not applicable.

### FIELD OF THE INVENTION

The present invention relates to the field of physical therapy apparatuses in general and in particular to the use of a retractable dog leash to provide a wide range of therapeutic exercises.

### DESCRIPTION OF RELATED ART

As can be seen by reference to the following U.S. Pat. Nos. 6,405,683; 6,352,495; 4,456,247; 4,018,189; and 3,853,283, the prior art is replete with myriad and diverse retractable leash assemblies, as well as, therapeutic exercise devices.

While all of the aforementioned prior art constructions are individually more than adequate for the basic purpose and function for which they have been specifically designed, they are uniformly deficient with respect to their failure to recognize the fact that a conventional retractable dog leash construction can be employed in a new and unique manner with only minor, if any, structural modifications to provide a patient undergoing physical therapy a means of performing self-stretching and/or range-of-motion exercises.

As a consequence of the foregoing situation, there has existed a longstanding need among individuals with physical and functional deficits due to a wide range of orthopedic and neurological problems for a new and improved general rehabilitation technique employing a retractable dog leash and the provision of this new technique and modified apparatus is the stated objective of the present invention.

### BRIEF SUMMARY OF THE INVENTION

Briefly stated, the method and apparatus that forms the basis of the present invention consists primarily of a conventional retractable dog leash wherein, an elongated leash strap having a snap clip provided on one end is operatively associated with a housing member containing a push button activated retraction mechanism to which the other end of the leash is operatively connected in a well recognized manner.

As will be explained in greater detail further on in the specification, the only potential modification that is contemplated to the retractable dog leash is the provision of a stop element proximate to, but spaced from, the snap clip on the terminal end of the leash strap in order to provide a defined loop that can accommodate a selected one of the user's limbs when the snap clip is engaged above the stop element in the direction of the housing member.

In addition, this invention further contemplates that the stop element will be adjustably positionable relative to the terminal end of the leash strap so as to allow the user to provide themselves with a custom fit for the particular appendage that is undergoing rehabilitation.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is a perspective view of the physical therapy apparatus used in a stationary resistance mode;

FIG. 2 is an isolated perspective view of the physical therapy apparatus; and,

FIG. 3 is a perspective view of the physical therapy apparatus employed in a range of motion exercise.

### DETAILED DESCRIPTION OF THE INVENTION

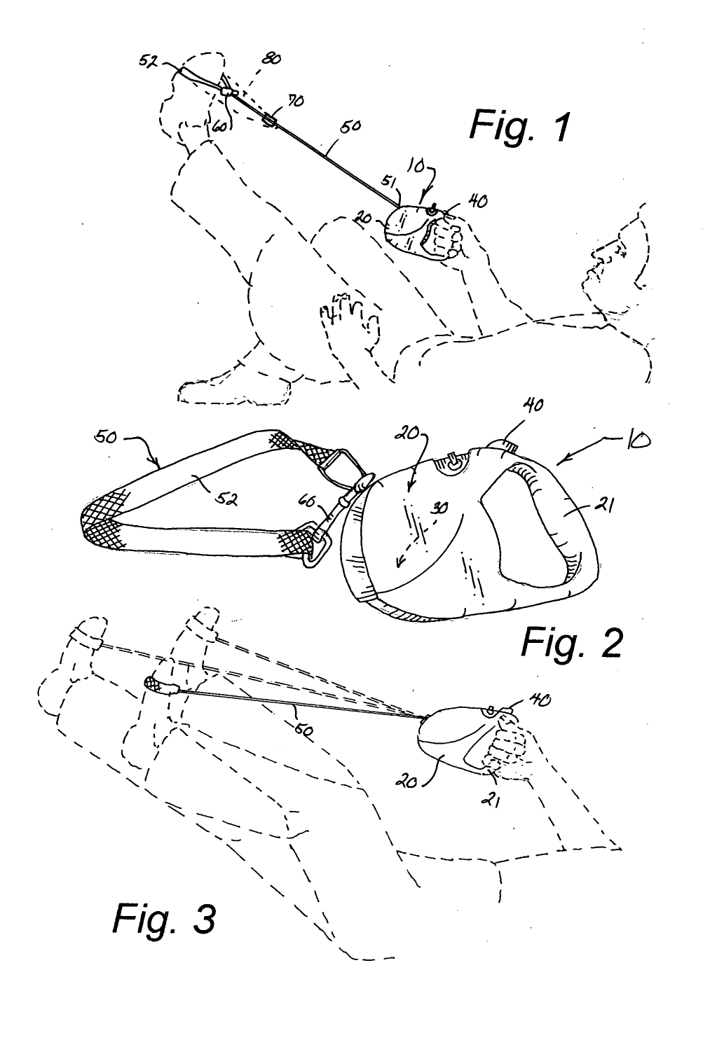

As can be seen by reference to the drawings, and in particular to FIG. 1, the physical therapy apparatus that forms the basis of the present invention is designated generally by the reference number 10 and includes a housing member 20 containing a conventional retraction mechanism 30 operated by a push button 40 wherein, an elongated leash strap 50 has a proximal end 51 connected to the retraction mechanism 30 and a distal terminal end 52 provided with a snap clip 60.

In addition, as shown in FIG. 1, the leash strap 50 is further provided with an optional adjustable stop element 70 which is disposed proximate to, but spaced from, the terminal end 52 of the leash strap 50 such that the snap clip 60 may be releasably attached to the leash strap 50 above the stop element 70 to form an appendage encircling loop 80 of a pre-determined size.

In practice, the user would then slip the loop 80 around a particular appendage and then use the push button 40 to allow a specific length of leash strap 50 to be withdrawn from the housing member 20 whereupon, the user would manipulate the housing member 20 via its ergonomically designed handle element 21 to perform a wide variety of self-stretching or range-of-motion exercises.

For example, FIG. 1 depicts a patient using the physical therapy apparatus 10 to perform a straight leg raise, while FIG. 3 shows the apparatus 10 employed for a hip external rotation. Furthermore, the apparatus 10 may also be utilized for the following physical therapy exercises: heel slide for hip and knee flexion, shoulder internal rotation, prone knee flexion, as well as, ankle dorsi-flexion to name but a few.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

We claim:

1. An apparatus for performing a wide range of self-stretching and range-of-motion exercises wherein, the apparatus comprises
a housing member having a handle element
a retraction mechanism disposed within the housing member
a push button operatively connected to the retraction mechanism and disposed on the exterior of the housing member
an elongated strap having a proximal end connected to the retraction mechanism and having a terminal end provided with a snap clip.

2. The apparatus as in claim 1 further comprising a stop element disposed proximate to, but spaced from, the terminal end of said elongated strap.

3. The apparatus as in claim 2; wherein, said stop element is adjustably positionable relative to the terminal end of said elongated strap.

4. A method of performing a wide variety of self-stretching and range-of-motion physical therapy exercises by employing a conventional retractable dog leash apparatus including a housing member having a handle element and a push button operatively associated with a retraction mechanism connected to one end of a leash strap the terminal end of which is provided with a snap clip comprising the steps of:
a) forming a loop on the terminal end of the leash strap by engaging the snap clip with a spaced portion of the leash strap
b) engaging the loop with a selected appendage of the user
c) engaging the push button on the housing member to pay out a selected length of the leash strap; and,
d) engaging the handle element of the housing member to manipulate the selected appendage in accordance with a physical therapy regimen.

5. The method as in claim 4; wherein, the conventional dog leash apparatus is provided with a stop element disposed proximate to, but spaced from, the terminal end of the leash strap and including the intermediate step of:
e) engaging the snap clip above the position of the stop element.

6. The method as in claim 5; wherein, said stop element is adjustably positionable on the leash strap and further including the intermediate step of:
f) positioning the stop element at a selected location on the leash strap to form a loop of a specific size when the snap clip is engaged with the leash strap according to step e).
